(19) United States
(12) Patent Application Publication
(10) Pub. No.: US 2003/0075974 A1
(43) Pub. Date: Apr. 24, 2003

(54) Brake system with a filter that can be bridged at low temperatures

(76) Inventors: Peter Tandler, Kronberg/Ts. (DE); Peter Volz, Darmstadt (DE)

Correspondence Address: RATNERPRESTIA, P O BOX 980, VALLEY FORGE, PA, 19482-0980, US

(21) Appl. No.: 10/267,510

(22) Filed: Oct. 9, 2002

(30) Foreign Application Priority Data
Oct. 10, 2001 (DE) 101 49 847.0

(51) Int. Cl. B60T 8/32

(52) U.S. Cl. 303/113.1; 303/191

(57) ABSTRACT

The present invention relates to a filter fitted into a flow connection of a controlled brake system. The brake fluid is very viscous at low temperatures. Therefore, great pressure loss is encountered at the filter, adversely affecting the control behavior of the brake system. The present invention discloses bridging the route of the brake fluid flow at low temperatures via the filter at least in part, which is done by means of a temperature-responsively controlled valve.

### FIELD OF THE INVENTION

The present invention relates to a brake system wherein brake fluid is transmitted from individual components of the system to others by way of flow connections. Brake systems of this type are usually designed as controlled brake systems, and the braking operation is controlled in dependence on the slip measured on a wheel. Difficulties may be encountered in controlled brake systems when the brake fluid is so viscous at low temperatures that the transport of the brake fluid from individual components of the system to others is no longer ensured, said fluid flow being required for a quick control operation. This applies in particular in case it is necessary to build up brake pressure at low temperatures, when no brake fluid under such a pressure is available at low temperatures. This is e.g. the case if it is desired to operate individual wheel brakes without there being any request of the driver for a braking operation (start up of the vehicle on slippery roadways (traction control); intervention of the brakes in the event of oversteering or understeering during cornering in order to maintain the vehicle on the desired track [(ESP)].

As a remedy, brake systems have been equipped with accumulators providing pressurized brake fluid at very low temperatures. Other solutions are directed to providing appropriate pumps for the mentioned purposes. If the brake fluid is very viscous (high viscosity), the flow resistance that is due to the necessary filters in the system is at a particularly high rate.

### BRIEF SUMMARY OF THE INVENTION

Therefore, the present invention is based on a brake system wherein brake fluid is transmitted from individual components of the system to others by way of flow connections, with at least one filter inserted into the system.

An object of the present invention is to prevent the pressure decline at the filter(s) particularly occurring at low temperatures so that the brake system optionally manages without additional accumulators or pumps. This object is achieved by the combination of the features that a flow path is connected in parallel to the filter, and that this flow path can be opened or closed in dependence on a temperature-controlled valve. Hence, the present invention in principle resides in arranging for a flow path to be connected in parallel to the filter, the flow path permitting to be opened or closed in dependence on the prevailing temperature.

It is therefore possible by way of the present invention to counteract the pressure decline of the flowing brake fluid that occurs at the filter at low temperatures, while the effect of the filter during this time is consciously dispensed with in part.

Filters cooperating with a valve are already known in brake systems. The objective of valves of this type is to ensure that the flow of brake fluid is not interrupted due to a filter being clogged by contaminants. As either a pressure in excess of atmospheric pressure develops in front of the filter or a vacuum develops behind the filter when the filter is clogged, the forces that act due to the respective pressure are used to open the mentioned valve, thereby reducing the pressure decline at the valve by the valve providing a flow path that permits short-circuiting the flow connection by way of the filter at least in part. In a preferred aspect of the present invention, the combination of features that the control element is a spring which is designed or mounted in such a fashion that it opens when forces are exerted by the brake fluid on the valve member due to a clogged filter and at a simultaneously prevailing normal temperature is disclosed in order not to dispense with the above effect of the prior art valve. This way the valve opens both at low temperatures and at a normal temperature when the filter is clogged with dirt.

In a preferred aspect of the present invention, the combination of features that the valve includes a bimetal strip engaging a valve member of the valve is used to achieve a low-cost control element of simple design for the valve member. The combination of the features that the filter has a cylindrical configuration, and that the flow path which extends through the peripheral surface of the cylinder can be short-circuited by a flow path which connects the outside surface of the filter to the interior of the filter and leads through a valve, said valve being adapted to be actuated by a temperature-responsively operable control element describes a space-saving filter configuration. To define the fitting position of the filter, it is advisable to use the features that there is provision for a compensating reservoir which is connected to a return conduit and a discharge conduit, the filter being mounted into the return conduit or the discharge conduit in a preferred aspect of the invention. The fitting positions described above have proven favorable because the brake fluid is replenished by way of the reservoir and any dirt that may be produced is transported back to the reservoir by way of the return path in the brake system.

Additional space is economized according to the features that the filter is mounted into the outlet socket of the reservoir. To this effect, the filter may be connected detachably to the reservoir in the way of a cartridge, or may also be anchored in the reservoir in a non-detachable manner.

It is often desirable to open the filter only as far as necessary to prevent the effect of the filter from being unnecessarily limited. To reach this aim in a simple manner, it is advisable to apply the combination of features that the width of opening of the valve depends on the temperature, preferably the temperature of the brake fluid as a preferred aspect of this invention. Thus, the valve opens only to the extent deemed appropriate due to the prevailing temperature. The ambient temperature of the vehicle may be used as the temperature. However, it is more suitable to use the temperature of the brake fluid as the controlling temperature because it is possible that the brake fluid reaches a normal temperature even at low outside temperatures. This may e.g. occur because the brake fluid heats on account of braking operations. The effect of the filter is not impaired in this case, not even at low outside temperatures.

### BRIEF DESCRIPTION OF THE DRAWINGS

An embodiment of the present invention will be explained in the following by way of the accompanying drawings. In the drawings,

FIG. 1 shows the filter of the present invention mounted into a capsule.

FIG. 2 shows the filter of the present invention integrated in a reservoir.

### DETAILED DESCRIPTION OF THE PREFERRED EMBODIMENTS

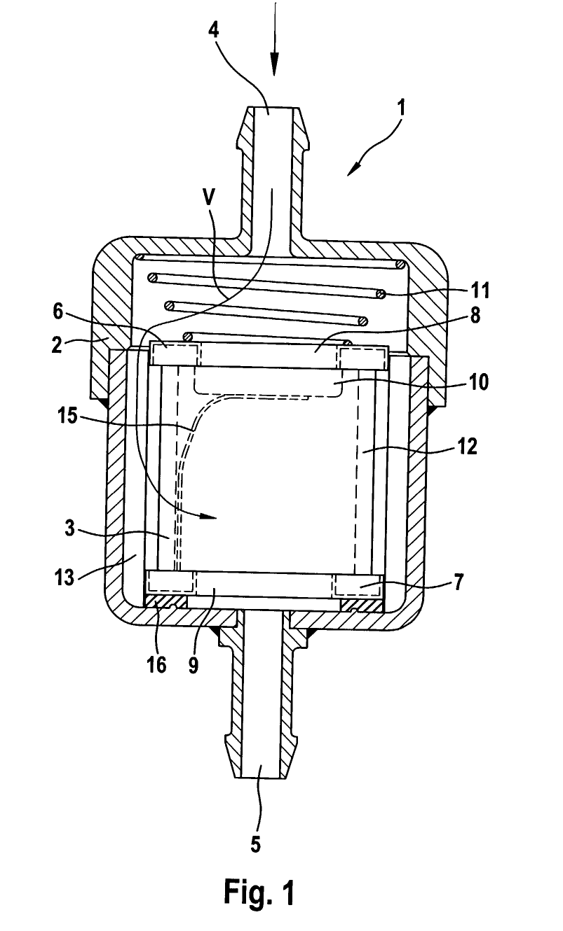

FIG. 1 shows a filter 1 having a cylindrical filter cartridge 3 inserted into a casing 2. The casing 2 of filter 1 has an inlet 4 and an outlet 5, and the inlet 4 can be connected to a compensating reservoir (not shown), while the outlet 5 leads to a pump (not shown). The filter cartridge 3 has a first front part 6 and a second front part 7. The first front part 6 includes a first through-bore 8, and the second front part 7 includes a second through-bore 9. The first through-bore 8 is adapted to be closed by a valve member 10. A sealing spring 11 makes catch at the first front part 6 and, with its other end, is supported on the bottom of the casing 2. The peripheral surface of the cylinder of cartridge 3 is formed of a filter paper 12 arranged like a coil. The bottom part of housing 2 includes ribs 13 supporting the cartridge 3 at the lateral surfaces of the front parts 6, 7. A spring 15 made of bimetal is supported on one of the front parts, e.g. the second front part 7, and the other end of said spring engages the valve member 10 and, under bias, closes the first through-opening 8 in this way.

The path of the flow connection V extends from the inlet 4 through the interior of casing 2 between the ribs 13 through the filter paper 12 into the interior of the cartridge 3. From there the pressure fluid (brake fluid) propagates through the second through-bore 9 to the outlet 5. To prevent brake fluid from directly propagating from the spaces intermediate the ribs 13 to the outlet 5, the sealing spring 11 presses the second front part 7 of cartridge 3 against an annular seal 16.

When the temperature of the brake fluid adopts a sufficiently low degree, the bimetal spring 15 will deform in such a manner that the valve member 10 in FIG. 1 moves in a downward direction, thereby opening the valve. As this occurs, it is preferred that the opening travel depends on the brake fluid's temperature. This means, the lower the temperature of the brake fluid, the wider the valve will open. At least parts of the brake fluid are now allowed to flow through the first through-bore 8 into the interior of the filter cartridge 3, and from this location to outlet 5. This arranges for a flow path by way of the first through-bore 8 through which the flow connection V is short-circuited or by-passed at least partly.

When the filter paper 12 is clogged with dirt and the filter hence obstructed, a pressure in excess of atmospheric pressure is able to develop upstream of the valve member 10 or a vacuum downstream of the valve member 10 in FIG. 1, depending on whether the brake fluid is sucked off by a pump from the inlet 4 or the outlet 5. Irrespective of this circumstance a force develops tending to move the valve member 10 in a downward direction in FIG. 1 and hence opening the valve. The spring 15 fulfils a second function this way by yielding due to the clogged filter when pressure forces act on the valve member 10, with the valve opening accordingly. This requires selecting the design of the spring 15 which is preferably made of a bimetal or any memory metal to be such that the spring deforms to a sufficient extent at low temperatures, while it is resilient enough to yield elastically when forces act on the valve member 10.

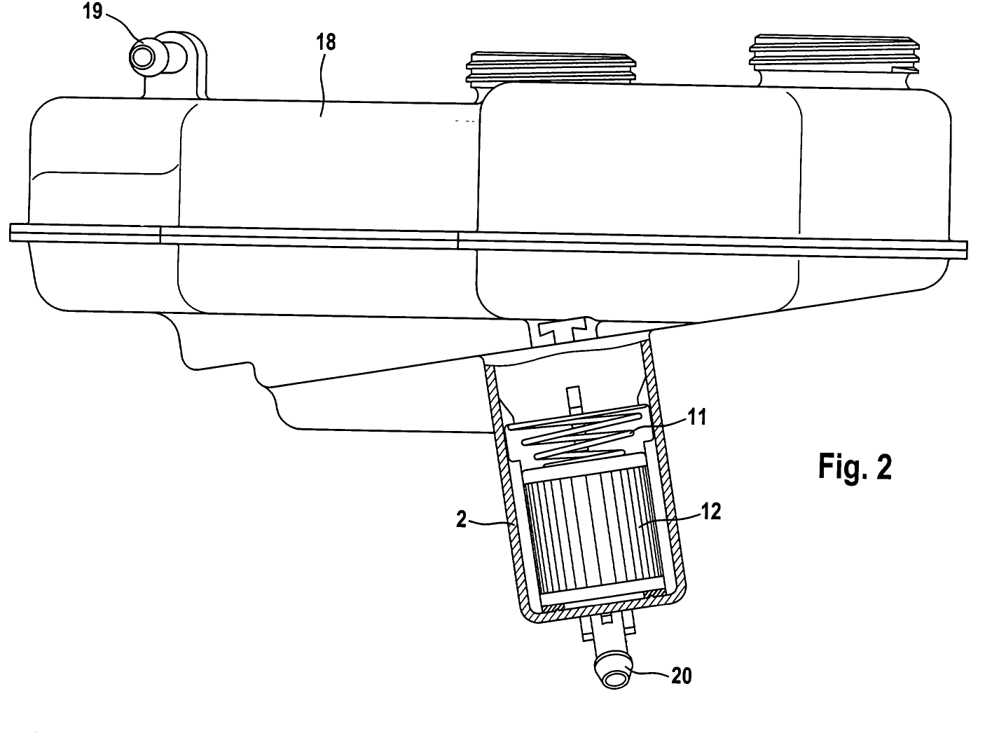

FIG. 2 shows an embodiment of the present invention wherein the filter 1 according to FIG. 1 is integrally designed with a supply reservoir 18. In this arrangement, especially the casing 2 of the filter is integrally connected to the bottom part of the reservoir 18. However, it is also possible to provide a seat for the filter 1 in the reservoir 18, said seat being closed by a special cover permitting the filter 1 to be exchanged. The pressure fluid will thus flow from the inlet 19 of the reservoir 18 via the filter 2 to the outlet 20 of the reservoir. The spring 11 in the present case is not supported on the bottom of the housing 2 but on the sidewall of the housing 2. Special projections are is provided in the casing to make this support possible.

What is claimed:

1. Brake system wherein brake fluid is transmitted from individual components of the system to others by way of flow connections, with at least one filter inserted into the system,
characterized in that a flow path is connected in parallel to the filter, and that this flow path can be opened or closed in dependence on a temperature-controlled valve.

2. Brake system as claimed in claim 1, characterized in that the valve member of the valve can be actuated by a control element which opens at low temperatures of the valve and closes at normal temperatures.

3. Brake system as claimed in claim 2, characterized in that the control element is a spring which is designed or mounted in such a fashion that it opens when forces are exerted by the brake fluid on the valve member due to a clogged filter and at a simultaneously prevailing normal temperature.

4. Brake system as claimed in claim 3, characterized in that the valve includes a bimetal strip engaging a valve member of the valve.

5. Brake system as claimed in claim 1, characterized in that the filter has a cylindrical configuration, and that the flow path which extends through the peripheral surface of the cylinder can be short-circuited by a flow path which connects the outside surface of the filter to the interior of the filter and leads through a valve, said valve being adapted to be actuated by a temperature-responsively operable control element.

6. Brake system as claimed in claim 1, characterized in that there is provision for a compensating reservoir which is connected to a return conduit and a discharge conduit, the filter being mounted into the return conduit or the discharge conduit.

7. Brake system as claimed in claim 6, characterized in that the filter is mounted into the outlet socket of the reservoir.

8. Brake system as claimed in claim 1, characterized in that the width of opening of the valve depends on the temperature, preferably the temperature of the brake fluid.

9. Brake system as claimed in claim 2, characterized in that the width of opening of the valve depends on the temperature, preferably the temperature of the brake fluid.
